(19) United States
(12) Patent Application Publication
(10) Pub. No.: US 2010/0006545 A1
(43) Pub. Date: Jan. 14, 2010

(54) Welding of Pipeline to Enhance Strain Performance

(76) Inventors: Mario L. Macia, Bellaire, TX (US); Karel Minnaar, Houston, TX (US); Scott D. Papka, Sugar Land, TX (US); Wlliam J. Sisak, Houston, TX (US)

Correspondence Address: Exxon Mobil Upstream;Research Company, P.O. Box 2189, (CORP-URC-SW 359), Houston, TX, 77252-2189, US

(21) Appl. No.: 12/086,367

(22) PCT Filed: Oct. 23, 2006
(86) PCT No.: PCT/US2006/041490

§ 371 Date: Sep. 15, 2009

(51) Int. Cl. B23K 31/12; B23K 31/02; B23K 9/00; F16L 9/19; G06F 17/10

(52) U.S. Cl. 219/74; 228/225; 228/103; 219/137 R; 138/111; 703/2

(57) ABSTRACT

A method and apparatus utilized in forming weld joint is described. In the method, a strength weld between two members is formed by a first welding process and a first weld metal. Then, one or more strain welds are formed by depositing a second weld metal adjacent to the strength weld using a second welding process. The strain welds are configured to form a weld joint having a specific minimum height and width to handle tensile strain to a specific strain capacity.

### CROSS REFERENCE TO RELATED APPLICATIONS

This application claims the benefit of U.S. Provisional Application No. 60/752,785, filed 22 Dec. 2005.

### FIELD OF THE INVENTION

The present techniques generally relate to welding methods and apparatus. More particularly, the present techniques relate to methods of welding pipe segments within a pipeline to enhance strain capacity.

### BACKGROUND

This section is intended to introduce the reader to various aspects of art, which may be associated with exemplary embodiments of the present techniques, which are described and/or claimed below. This discussion is believed to be helpful in providing the reader with information to facilitate a better understanding of particular aspects of the present techniques. Accordingly, it should be understood that these statements are to be read in this light, and not necessarily as admissions of prior art.

The production of hydrocarbons, such as oil and gas, has been performed for numerous years. To produce these hydrocarbons, one or more wells of a field are typically drilled into a subsurface location, which is generally referred to as a subterranean formation, basin or reservoir. From the wells, lines or pipelines are utilized to carry the hydrocarbons to a surface facility for processing or from surface facility to other locations. These pipelines are typically formed from pipe segments that are welded together at weld joints to form a continuous flow path for various products. As such, these pipelines provide a fluid transport system for a wide variety of products, such as oil, gas, water, coal slurry, etc.

Generally, pipelines may be affected by various forces that may damage or rupture the pipeline. Recently, increased demand for oil and gas has provided a significant incentive to place pipelines in geographic regions with large ground deformations. Placing pipelines in these regions presents engineering challenges in pipeline strength and durability that were not appreciated or approached in the past. These large ground deformations may occur in seismic regions, such as around fault lines, or in arctic regions. In these regions, pipelines may be subjected to large upheaval or subsidence ground movements that occur from the ground freezing/thawing and/or large horizontal ground movements that occur from earthquake events. Because of the ground movements, pipelines, which may be above or below ground, are subject to strains that may disrupt the flow of fluids. Further, various load conditions, such as force-controlled load conditions, may be applied to the pipeline as internal pressures and external pressures. In particular, if the pipeline is subjected to predominantly force-controlled load conditions, an allowable stress design methodology is utilized to ensure that the level of stress in the pipeline remains below the yield strength of the pipeline material.

In addition, because the pipe segments are welded together, the weld joints between the pipe segments or between the pipe segments and auxiliary components, such as elbows or flanges, may provide weak points that are susceptible to these forces. For instance, a weld joint between two pipe segments may have flaws that weaken the pipeline. If the weld joint has flaws, then the pipeline may fail at the weld joint due to load conditions or ground movement. Accordingly, the weld joints of the pipe segments may have to be designed to have sufficient strength and fracture toughness to prevent failure of the weld joint.

Many of the prior methods did not provide for plastic deformation of the pipe. Therefore, pipeline designs placed in areas of large ground deformation utilized stress-based design approaches. Accordingly, various methods have previously been described that involve forming various weld overlays designed to address fractures around the weld joints. However, these methods do not address the susceptibility of plastic collapse in a structural member containing flaws, which are placed under larger deformation loads that result in gross plasticity through the thickness of the structural member, such as the pipe segments. Indeed, these methods fail to address how the geometry of the weld reinforcement may be manipulated to enhance the tensile strain capacity of the welded pipeline.

Prior welding methods are more specifically described in U.S. Pat. Nos. 4,049,186 to Hanneman et al. (Hanneman) and 4,585,917 to Yoshida et al. (Yoshida). In Hanneman, the patentees were concerned with stress corrosion in welded pipe in nuclear reactor water lines. Hanneman utilized overlay welds to extend the weld constraint zone beyond the heat affected zone to reduce stress corrosion cracking of the welded pipe and prevent plastic deformation. In Yoshida, the patentees describe a method of welding to reduce residual stress in the welded pipe joint. The height and length of the build-up weld are calculated based on relative geometries of the pipe to reduce the residual stress.

Accordingly, the need exists for a method and apparatus that may be utilized to enhance the strain capacity of weld joints for pipe segments.

For additional information please reference U.S. Pat. No. 2,812,419; U.S. Pat. No. 2,963,129; U.S. Pat. No. 4,049,186; U.S. Pat. No. 4,585,917; U.S. Pat. No. 4,688,319; U.S. Pat. No. 4,823,847; U.S. Pat. No. 5,233,149; U.S. Pat. No. 5,258,600; U.S. Pat. No. 6,114,656; U.S. Pat. No. 6,336,583; U.S. Pat. No. 6,392,193; U.S. Pat. No. 6,565,678; U.S. Patent Publication No. 20020043305; and/or U.S. Patent Publication No. 20020134452. Further, additional information may be found in Denys R. M., “Wide Plate Test and its Application to Acceptable Defect” in Proceedings, Welding Institute Conference on Fracture Toughness Testing and Materials, Interpretation and Application, London, June 1982; and Norman E. Dowling, “Mechanical Behavior of Materials,” Prentice Hall, Englewood Cliffs, N.J. (1993).

### SUMMARY OF INVENTION

One embodiment of the present techniques is described as a method of enhancing the strain capacity of a weld joint. In this method, a strength weld between at least two members using a first welding process and a first weld metal is formed. Then, at least one strain weld is formed by depositing a second weld metal adjacent to the strength weld using a second welding process. The at least one strain weld is configured to form a weld joint having a specific minimum height and width to handle tensile strain to a specific strain capacity.

In an alternative embodiment, a system is described. The system includes a first tubular member, a second tubular member abutted to the first tubular member and a weld joint coupling the first tubular member with the second tubular member. The weld joint having a strength weld and a plurality of strain welds, wherein the weld joint has a specific minimum height and width to handle tensile strain up to a specific strain capacity.

In another alternative embodiment, an apparatus is described. The apparatus includes a processor, a memory coupled to the processor and an application accessible by the processor. The application is configured to obtain a predetermined strain capacity for a well completion; obtain a pipe segment material and weld metal material for a weld joint; utilize strain capacity data to determine the geometry of a weld joint based on the pipe segment material and weld metal material; and provide the geometry of a weld joint to a user.

In another embodiment of the present techniques a method of enhancing the strain capacity of a weld joint is described. In this method, a specific minimum height and width of at least one strain weld to handle tensile strain to a specific strain capacity is determined. Then, a strength weld between at least two members using a first welding process and a first weld metal is formed. Then, the at least one strain weld is formed by depositing a second weld metal adjacent to the strength weld using a second welding process.

In a further embodiment of the present techniques a method of determining a weld geometry is disclosed. The method includes determining a specific strain demand on the members to be welded, then determining the most appropriate pipe segment material. A weld material and welding process are selected, then a specific minimum height and width of at least one strain weld is determined to achieve a strain capacity up to the determined specific strain demand.

### BRIEF DESCRIPTION OF THE DRAWINGS

The foregoing and other advantages of the present technique may become apparent upon reading the following detailed description and upon reference to the drawings in which:

FIG. 1 is an exemplary production system in accordance with certain aspects of the present techniques;

FIGS. 2A-2B are conventional weld joints formed between two pipe segments;

FIG. 3 is an exemplary chart of material stress-strain behavior;

FIG. 4 is an exemplary flow chart of a method that enhances strain capacity of a weld joint for the pipeline of FIG. 1 in accordance with aspects of the present techniques;

FIGS. 5A-5E are exemplary embodiments of a weld joint between two pipe segments based on the method of FIG. 4 in accordance with aspects of the present techniques;

FIGS. 6A-6D are exemplary profiles of weld joints in accordance with aspects of the present techniques; and

FIG. 7 is an exemplary embodiment of an additional weld joint formed from the method of FIG. 4 in accordance with aspects of the present techniques.

### DETAILED DESCRIPTION

In the following detailed description, the specific embodiments of the present invention will be described in connection with its preferred embodiments. However, to the extent that the following description is specific to a particular embodiment or a particular use of the present techniques, this is intended to be illustrative only and merely provides a concise description of the exemplary embodiments. Accordingly, the invention is not limited to the specific embodiments described below, but rather, the invention includes all alternatives, modifications, and equivalents falling within the true scope of the appended claims.

The present technique is directed to a method of forming weld joints that enhance strain capacity relative to conventional welding procedures. Under the present technique, various overlaying welds or strain welds may be utilized with strength welds, cap welds and/or toughness welds to alter the geometry of the weld joint. Based on this geometry, which includes a specific height and width, the weld joint may be able to handle large strains, up to and beyond the pipe's strain capacity, in the direction of the axis of the welded members, such as pipe segments. Accordingly, the addition of these strain welds may be utilized to enhance strain capacity.

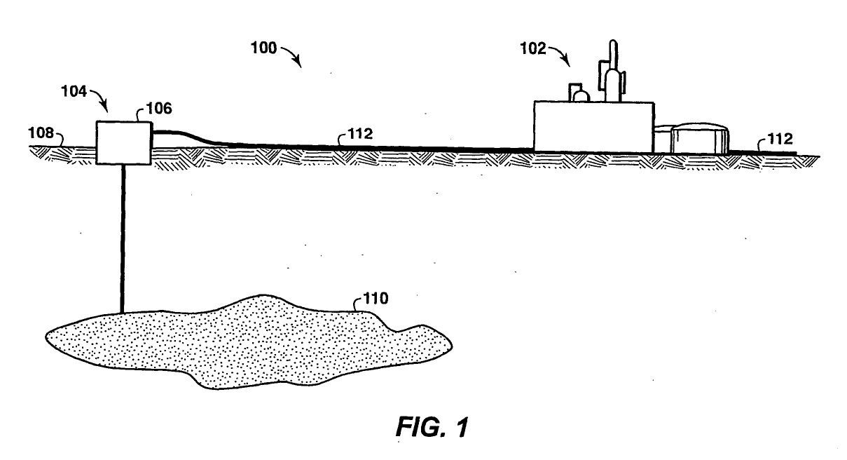

Turning now to the drawings, and referring initially to FIG. 1, an exemplary production system 100 in accordance with certain aspects of the present techniques is illustrated. In the exemplary production system 100, a surface facility 102 is coupled to a well 104 via a tree 106 located on the surface 108 of the earth. The surface facility 102 may be a processing plant, oil refinery, pumping station, storage tank, or other facility. To provide fluids from the subsurface reservoir 110, the well 104 penetrates the earth's surface 108 and extends to and through at least a portion of a subsurface reservoir 110. As may be appreciated, the subsurface reservoir 110 may include various layers of rock that may include fluids, such as water, oil and/or gas. The well 104 provides a flow path for these fluids from the subsurface reservoir 110 to the surface facility 102. However, it should be noted that the production system 100 is illustrated for exemplary purposes and the present techniques may be useful in the transport of fluids from any location.

To transport the fluids from the tree 104 and surface facility 102, pipe segments or pipelines 112 may be utilized. As may be appreciated, the pipelines 112 may include different sections of tubular members or pipe that are welded together to form the pipelines 112. The pipe segments may be fabricated from steel, steel alloys and other materials to provide specific strengths. The range of material strength may vary from a specified minimum yield of 35 kilo pounds per square inch (ksi) to 120 ksi. The properties of pipes commonly used for pipelines are described in linepipe standards such as American Petroleum Institute (API) 5L, International Organization for Standardization (ISO) 3183 and Canadian Standards Association (CSA) Z245.1.

To provide fluid communication between different locations, such as the tree 104 and the surface facility 102 or from the surface facility to the location of the end user, the pipeline 112 may have to span large distances. Accordingly, the pipelines 112 may be affected by various forces that may damage or rupture the pipelines 112. For instance, as noted above, the pipeline 112 may be located in regions where large ground deformations are possible, due to seismic activity, such as the pipeline being located near fault lines, and/or environmental factors, such as the freezing and thawing in arctic regions.

Further, various load conditions, such as force-controlled load conditions and deformation-controlled load conditions, may be applied to the pipeline 112, such as internal pressures, external pressures, bending moments, tensile load thermal load, and large ground deformations, for example. In particular, if the pipeline 112 is subjected to predominantly force-controlled load conditions, an allowable stress design methodology may be utilized to design the pipeline 112. In this example, the pipeline 112 is configured or designed to ensure that the level of stress in the pipe segments and weld joints remains below the yield strength of the pipe segment material. Alternatively, if the pipeline 112 is subjected to predominantly displacement controlled load conditions; a strain based design methodology may be utilized to design the pipeline 112. In this case, the pipeline is designed to ensure that the level of strain in the pipeline remains below the strain capacity of the pipe segments and weld joints.

Due to these conditions, different materials may be selected for the pipe segments and weld joints of the pipelines 112 to ensure that sufficient strain capacity is available to meet or exceed a predetermined strain demand. The strain capacity is the capacity of the pipeline 112 to sustain tensile strains when being stretched. In addition, the pipe segments and weld joints of the pipelines 112 may also be configured to ensure that the pipeline 112 has sufficient strength and fracture toughness.

Typically, the strain capacity of the pipeline 112 may further be limited by the weld joints because the weld joints may contain imperfections that limit the tensile strains that may be sustained by the weld joints. These imperfections may be flaws, such as cracks or spaces, formed in or between the weld joints and/or in or between the weld joints and the pipe segments. The strain capacity of the weld joints, which are sensitive to the flaw size, may decrease with an increase in flaw size. Therefore, the strain capacity may be characterized as a function of flaw size.

Accordingly, to address the strain capacity, weld joints are inspected during pipeline construction, and flaws larger than the specific size are removed or repaired. Flaw size is typically defined by flaw length and flaw depth. Because the removal and repair of these weld flaws is costly, construction costs may be reduced by increasing the acceptable flaw size to reduce the number of repairs. Accordingly, one approach is to increase the strain capacity of the pipeline to produce a girth weld metal with higher yield strength than the pipe segment material. The percentage difference in strength between the girth weld metal and the pipe segment material is called overmatching. Therefore, to enable weld joints to tolerate large plastic strains, designers select pipe, girth welding consumables and processes that produce a weld joint that has sufficient strength to overmatch the strength of the pipe segments and sufficient fracture toughness to prevent fracture. However, as the strength of pipe segment materials increases, it becomes more difficult to consistently overmatch the strength of the pipe segments because the strength produced by available weld materials is limited. For instance, with X120 and X100 grade linepipes, it may be difficult to consistently achieve overmatching girth welds that are capable of sustaining large plastic strains.

In addition, the welding processes may produce a softened heat affected zone (HAZ) between the weld and pipe segment interface. The HAZ is a portion of the pipe segment with the microstructure altered and the mechanical properties changed by the heat from the welding process. The softened HAZ may result in the formation of strain localization at lower overall pipe deformations. This localized strain in the HAZ reduces the strain capacity of welded pipelines. In addition, the welding process may produce local brittle zones (LBZs) in the HAZ that are susceptible to brittle fracture. The formation and characteristics of LBZs are described in detail in D. P. Fairchild, “Welding Metallurgy of Structural Steels”, Proceedings of an International Symposium on Welding Metallurgy of Structural Steels, The Metallurgical Society, Inc., February 1987, pages 303-318.

To address this type of failure, various other techniques have utilized overlays to reduce effects of flaws within the HAZ. For example, as discussed in U.S. Pat. No. 6,336,583, which is hereby incorporated by reference, describes a method for producing welded joints having improved low temperature toughness. In this patent, a weld overlay is utilized to strengthen the weld by applying toughness welds adjacent to a weld cap, wherein the toughness welds are placed over the weld toe of the primary strength weld. The toughness welds are utilized to increase resistance to brittle fracture, which may be near cryogenic temperatures.

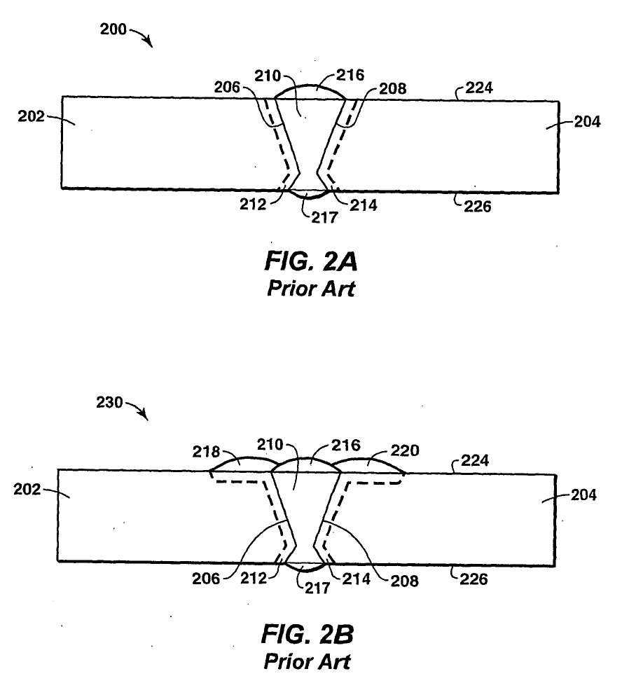

As an example how U.S. Pat. No. 6,336,583 may be applied to a pipeline weld, FIG. 2A illustrates a conventional weld joint 200 between two pipe segments and FIG. 2B illustrates a weld joint 201 produced according to the process of U.S. Pat. No. 6,336,583. In FIG. 2A, the joining edges 206 and 208 of two pipe segments 202 and 204 are beveled by methods that are well known to those skilled in the art and that are consistent with deposition of a selected weld metal into the groove formed by the beveled joining edges 206 and 208 to form a strength weld 210. The weld metal of the strength weld 210 may include ferritic welding consumables, austenitic welding consumables and any combination thereof. The heat of welding forms HAZs 212 and 214 proximate to the interface between the joining edges 206 and 208 and the strength weld 210. As discussed above, the HAZs 212 and 214 are portions of the pipe segments 202 and 204 that have not been melted, but in which the microstructure and mechanical properties have been altered by the heat of welding. An outer weld cap 216 is positioned along the outer surface 224 of the pipe segments 202 and 204. In FIG. 2B, toughness welds 218 and 220 are positioned along the outer surface 224 of the pipe segments 202 and 204 next to the outer weld cap 216. The additional toughness welds 218 and 220 are utilized to reduce or prevent brittle fracture of the weld in the HAZs 212 and 214.

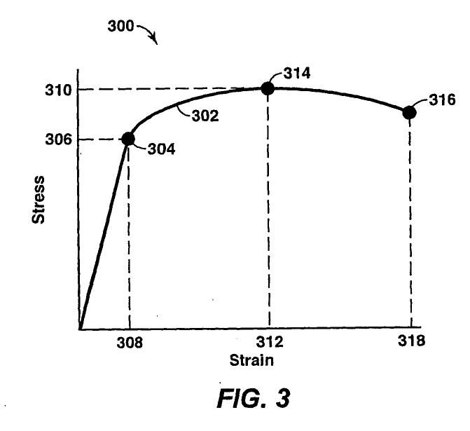

However, the toughness welds 218 and 220 do not address the susceptibility of plastic collapse in a structural member containing flaws which are placed under larger deformation loads. If the material fracture toughness is sufficient to avoid brittle fracture, the toughness welds 218 and 220 are not utilized to prevent brittle fracture at a stress and strain range below the yield point of the material, which is discussed further in FIG. 3. In this situation, the deformation loads may result in gross plasticity through the thickness of the structural member, such as a pipe segment. As such, other techniques do not adjust the geometry of the reinforcement welds to enhance the tensile strain capacity of welded pipe segments in the pipeline.

Elastic deformation involves the stretching of chemical bonds. When a material that is elastically deformed is unloaded, the deformation disappears and the material returns to its original shape and size. With steels, stress and strain are proportional when the material is deformed elastically. However, if a material is deformed plastically, atoms in the material are rearranged, which results in permanent deformation that does not disappear when the load is removed. For example, many standards describe a tension test and a general description of the tests, which is described in FIG. 3 below. See Norman E. Dowling, “Mechanical Behavior of Materials,” Prentice Hall, Englewood Cliffs, N.J. (1993). A chart of the stress-strain response of a steel or steel alloy material is shown in FIG. 3.

In FIG. 3, the stress-strain behavior of materials is obtained experimentally by pulling a tension specimen in tension until the specimen breaks in two. In this chart, which is herein referred to by reference numeral 300, stress-strain behavior of a material is shown along a stress-strain response 302. The yield point 304 defines the location on the stress-strain response 302 where plastic deformation initiates. Below the stress 306 and strain 308 associated with the yield point 304, the stress-strain response 302 is linear. The stress-strain response 302 is non-linear for deformations that results in stresses above the stress 306 associated with the yield point 304 of the material. There exist various definitions of yield stress. For example, the 0.2% strain offset yield method may be used to define the yield point 304. As stress increases with increases in strain beyond the yield point 304, the stress increases to reach a maximum value of stress or ultimate material strength 310 at yield point 314 on the stress-strain response 302, which corresponds to a strain 312, which is referred to as the limit of uniform elongation. Deformations larger than the limit of uniform elongation cause a reduction in stress or a reduction in the load carrying capacity of the material, such as pipe segments, which indicate the onset of plastic collapse. The reduction in load carrying capacity continues until final fracture occurs at a yield point 316 on the strain stress response 302 corresponding to an engineering fracture strain 318.

If a steel or steel alloy pipe is pulled in tension, the longitudinal stress and longitudinal strain responds in a similar fashion as the curve represented in FIG. 3. Deformation is characterized as elastic for stresses below the yield stress 306 and plastic for deformations above the yield stress 306. Furthermore, the strain capacity, which is at the strain 312, of a pipe is the strain corresponding to the point 314 at which maximum stress 310 is obtained.

The various loads applied to a pipeline may include pure force-controlled load conditions to pure deformation-controlled load conditions, as discussed above. If the pipeline is subjected to predominantly force-controlled load conditions an allowable stress design methodology is followed. In this case, the designer provides a pipeline to ensure that the level of stress in the pipeline remains below the yield strength of the pipeline material. However, if the pipeline is subjected to predominantly displacement-controlled load conditions, a strain based design methodology may be followed.

In the case of deformation-controlled load conditions, the designer calculates the strain demand that will be imposed on the pipeline due to ground movement. Strain demand is the total tensile strain that may be imposed on pipe segment due to the application of bending, tensile, thermal and pressure loads. Accordingly, to address the strain demand, the pipeline 112 may be configured to operate beyond the yield strength of the pipeline material in a strain-based design. That is, the pipeline material may be configured to be plastic and handle forces above the material yield point and strains above the elastic deformation limit. Examples of different forces experienced by pipelines in service, which cause the tensile plastic deformation of pipelines, may include displacements arising from fault movements, slope instabilities, frost heave, thaw settlement, and/or interaction with a reel barge in offshore pipeline installations.

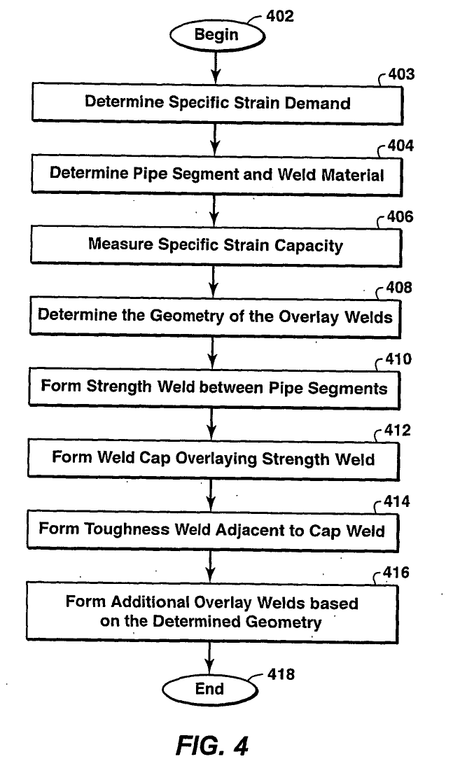

Beneficially, the present techniques are utilized to provide a method that prevents or delays the onset of plastic collapse in under-matched (pipe strength greater than weld metal strength), even-matched (pipe strength equal to weld metal strength), or over-matched (pipe strength less than weld metal strength) girth welds, which may be in the presence of a softened HAZ thereby increasing the strain capacity of a pipeline that contains flaws in the girth weld or girth weld HAZ. These techniques also reduce the potential of brittle fracture. As such, an enhanced welding method is discussed further in FIG. 4.

FIG. 4 is an exemplary flow chart of a method that enhances strain capacity of a weld joint for the pipeline 112 of FIG. 1 in accordance with aspects of the present techniques. This flow chart, which is referred to by reference numeral 400, may be best understood by concurrently viewing FIGS. 1 and 3. In this flow chart 400, a method is described that prevents or delays the onset of plastic collapse in under-matched or even-matched girth welds, which may include a softened HAZ. This method may increase the strain capacity of a pipeline, such as pipeline 112, which includes flaws in the girth weld or girth weld HAZ, by forming overlying or strain welds over the strength weld based on a specific geometry. The geometry of the overlay welds may include specific height and width to provide enhanced strain capacity for the weld joint.

The flow chart begins at block 402. At block 403, a strain demand for the pipeline 112 is determined. The determination of the strain demand may include experimental, experiential, or measured data. More specifically, it may involve sampling of soil conditions, characterizing potential seismic activity, predicting frost heave or thaw settlement due to temperature change, and identifying fault lines crossing the planned pipeline route. The geotechnical data and pipeline operating conditions are used as input for structural analyses to estimate the total strain demand that may be imposed on a pipeline.

At block 404, the pipe segment material and weld material are determined. The determination of the pipe material may include factors such as strength, plasticity, availability and economics. The pipe segment material may include steel or steel alloys ranging from Grade B to X120. The weld material may be selected based on the specific pipe material and welding process. For instance, the weld materials may include ferritic welding consumables, austenitic welding consumables and any combination thereof. Weld materials and processes are preselected to produce a range of mechanical properties including yield strength, ultimate strength and fracture toughness. The materials and processes are selected to provide a specific strain capacity. This selection may be based on prior experience and access to public or proprietary databases of weld performance.

At block 406, trial welds are produced and welded pipe samples are prepared for testing. Strain capacity is measured experimentally by conventional approaches. Typically, multiple welds are produced with a range of properties. Pipeline engineers may qualify welding procedures based on measured strain capacity of the welded pipe specimens.

The strain capacity is compared to the calculated strain demand. For example, in an arctic environment, the strain capacity may provide for a certain amount of movement for the pipeline 112 between two fixed locations, such as pipeline mounts. Alternatively, within a seismically active region, the strain capacity may provide for a certain amount of movement of the pipeline due to a seismic event, such as an earthquake. The strain capacity may be configured to be greater than the strain demand. The margin between strain capacity and strain demand is determined by the pipeline designer to ensure sufficient safety. Reliability methods may be used to determine the reliability of a strain based design. In the case of higher strength steels, such as X80 and higher grades, no welding consumable or procedure may be available to produce the required strain capacity. Accordingly, additional weld overlays may be utilized to increase pipeline strain capacity.

At block 408, the geometry of the overlay welds or strain welds that form the weld joint are determined. The determination of the overlay weld caps may include experience, experimentation and calculations. As an example, the geometry of the overlay weld caps may utilize a numerical simulation model to determine the influence of the geometry on the plastic response of the pipeline welded joint. Additional experimentation may be performed to qualify the overlay weld geometry to ensure sufficient strain capacity.

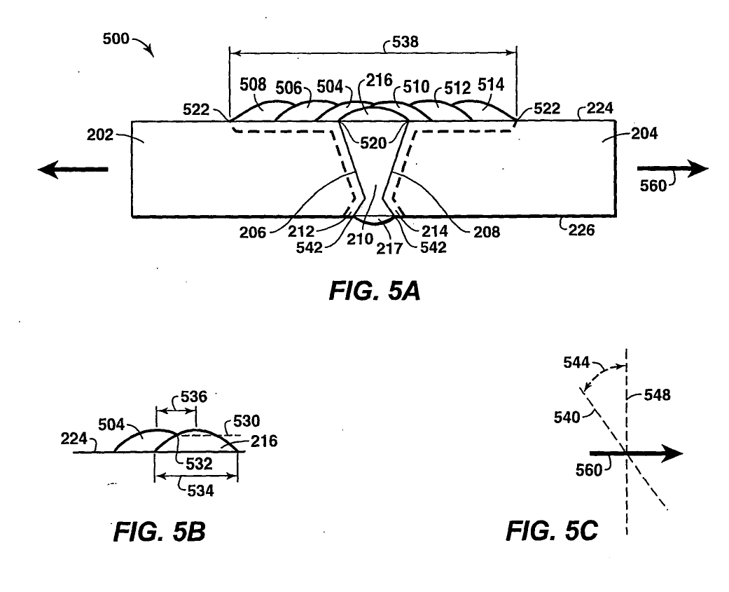

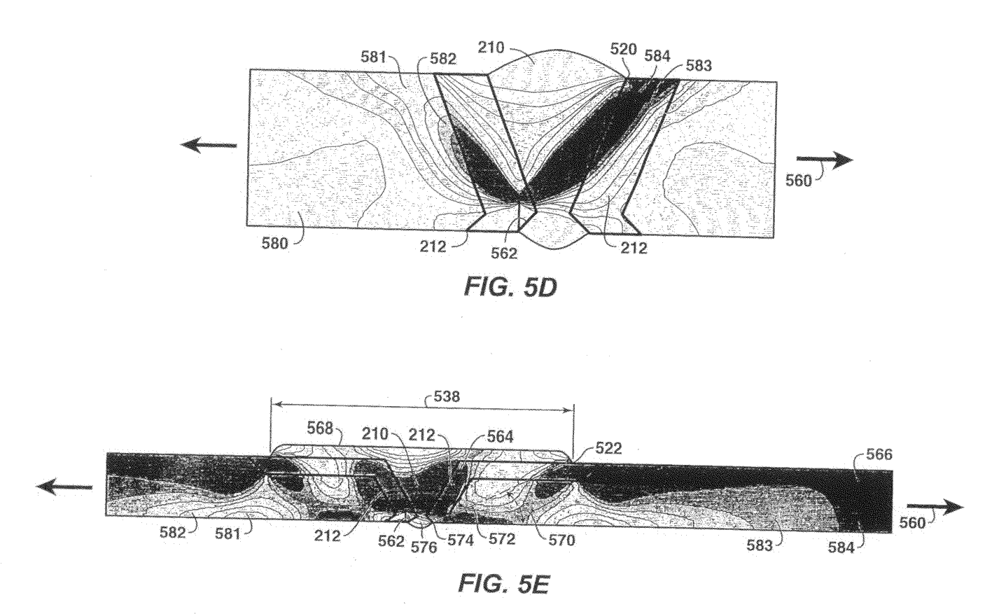

With the geometry of the overlay welds determined, different welds may be applied to the pipe segments as shown in blocks 410-416. To begin, a strength weld is formed between two pipe segments, as shown in block 410. The welding process that forms the strength weld may include fusion welding processes, such as gas tungsten arc welding, gas metal arc welding, shielded metal arc welding, submerged arc welding, fluxed core arc welding, plasma arc welding, and any combination thereof. At block 412, a weld cap may be formed overlaying the strength weld. The welding process to form the weld cap may include any of the welding processed discussed above, which may be the same or different from the processes utilized in block 410. Then, toughness welds may be formed adjacent to the cap weld, as shown in block 414. Again, the toughness welding process may include any of the welding processes discussed above, which may be the same or different from the processes utilized in blocks 410 and 412. Finally, based on the determined geometry, strain or overlay welds are formed adjacent to and overlaying the toughness welds and weld cap, as shown in block 416. The welding process utilized to form the strain welds may include any of the welding processes discussed above, which may be the same or different from the processes utilized in blocks 410, 412 and 414, and be applied as individual overlay passes or as a single weld overlay. The strain welds are discussed and shown in greater detail in FIGS. 5A-5E, 6B-6D and 7. Accordingly, the process ends at block 418. An example of a weld joint formed from this process is shown in FIGS. 5A-5E.

FIGS. 5A-5E are exemplary embodiments of a weld joint formed between two pipe segments based on the method of FIG. 4 in accordance with aspects of the present techniques. Accordingly, this weld joint, which is referred to by reference numeral 500, may be best understood by concurrently viewing FIGS. 1, 2A-2B and 4. The weld joint 500 may be capable of sustaining large strains in the direction of the axis of the pipe segments 202 and 204. As such, the weld joint 500 is useful to increase pipeline strain capacity when additional strain demand may be present for a pipeline, such as the pipeline 112.

In FIG. 5A, overlaying welds are utilized to form the weld joint 500 in a manner similar to the discussion of FIG. 2A-2B above. However, in this embodiment, additional overlay welds may be utilized instead of or in addition to the toughness welds 218 and 220. The additional weld metal, which is herein referred to as strain overlay welds or strain welds 504-514, are configured to form a weld joint 500 having a specific width and height that enhances the strain capacity of the weld joint 500. The weld metal utilized in these strain welds 504-514 may be the same or different types of weld metal that was utilized for the strength weld 210, as discussed above. To form these welds, the pipe segments 202 and 204, which may be steel pipes, are positioned relative to one another prior to the welding process, such that the inner and outer surfaces 224 and 226 of each segment are coaxial or aligned with one another and the joining surfaces 206 and 208 form a gap or groove suitable for application of a fusion welding process to join the pipe segments 202 and 204. The strength weld 210 is first formed between the pipe segments 202 and 204 by using a first weld metal and a first fusion welding process, while the weld cap 216 is formed over at least a portion of the strength weld 210. After completion of the strength weld 210, six to eight overlay welds 504-514 are deposited next to the weld cap 216 by using a fusion welding process to deposit additional weld metal. The first two overlay welds 504 and 510 are formed on the outer surface 224 adjacent to the weld cap 216 and covering the weld cap toes 520 on the outer surface 224. The additional strain welds 506, 508, 512 and 514 cover a portion or all of the adjacent strain welds 504, 506, 510 and/or 512, respectively, and a portion of the surface 224.

Because the strain welds 504-514 are configured to be a specific width and height, the weld joint 500 may enhance the strain capacity of the pipe segments 202 and 204 over other welding techniques. That is, the geometry of the strain welds 504-514 is adjusted to provide a predetermined strain capacity, assuming that the pipe segment material has sufficient strain capacity to meet the estimated strain demand. For example, the geometry of the weld joint 500 is defined by a minimum height 530 and a width 538 formed by the cap weld 216 and strain welds 504-514. For instance, as shown in FIG. 5B, the minimum height 530 is the distance from the outer surface 224 of the pipe segment 202 to the lowest point located at the valley 532 between the weld cap 216 and strain weld 504, as a example. This minimum height 530 may be increased to improve the strain capacity of the weld joint 500. That is, increasing the minimum height 530 strengthens the welded region or weld joint 500 relative to the base pipes 202 and 204 and delays the onset of strain accumulation in the weld HAZ 212 and 214 or the strength weld 210. Also, the shape of the strain welds 504-514 may be utilized to increase the minimum height 530 by adjusting the spacing distance 536 between the strain welds 504-514. The shape of the strain welds are determined by the strain weld width 534 and the maximum height of the strain weld. As such, as the welding process is repeated to deposit additional strain welds 506-514, the additional weld metal of the other strain welds 506-514 overlay a portion or all of the existing strain welds and may overlay a portion of the outer surface 224 of the pipe segments 202 and 204.

In addition to increasing the strain capacity, the configuration of strain welds 504-514 may be beneficial in reducing or preventing brittle fracture of the weld joint 500. Each overlay of additional strain welds 504-514 eliminates the previous weld toe and creates a new weld toe a distance away from the previous weld toe. The distance depends on the width 534 of the strain welds 504-514 passes and the spacing distance 536 between each of the strain weld passes. For instance, in the weld joint 500, the new weld toes 522 are formed between the outer surface 224 and the additional strain welds 508 and 514. As a result, the HAZ formed by the strain weld passes are oriented along a plane that is parallel to the direction 560 of the applied load.

In contrast, HAZ formed by the primary strength weld is oriented along a plane 540 that forms an angle 544 less than 45 degrees measured from a plane 548 perpendicular to the applied load, which is shown in FIG. 5C. The HAZ may contain local brittle zones. A crack located in the HAZ will have a tendency to follow the fusion line as it propagates through local brittle zones unless the HAZ makes an angle 544 greater than about 45 degrees. Therefore, the fracture toughness of the weld is improved by moving the weld toe into the HAZ region which is not oriented favorably to promote fracture propagation, which is discussed in U.S. Pat. No. 6,336,583.

Ductile materials generally fail due to plastic collapse on planes of maximum shear stress. The plane of maximum shear is oriented at an angle 544 forming 45 degrees from the plane 548 perpendicular to the direction 560 of applied tensile stress. The shear stress component increases from 0 in a plane 548 oriented perpendicular to the applied load and increases to a maximum on a plane that forms an angle 544 of 45 degrees to the direction 560 of the applied load. The susceptibility to plastic collapse is increased in a softened HAZ, due to the lower strength of the material located in the HAZ. Therefore, it is not necessary for the plane containing the HAZ to be oriented along the plane of maximum shear to cause plastic collapse within the HAZ. Typically, the plane containing the HAZ is oriented at an angle 544 less than 45 degrees to the plane 548 where the component of shear stress is non-zero. The HAZ formed by the strain welds are oriented along a plane that is parallel to the direction 560 of applied load. The shear stress in this plane is zero. Therefore, the susceptibility to plastic collapse is reduced in the HAZ formed by the additional strain welds. The additional weld overlays delay the onset of plastic collapse through two mechanisms. Firstly, the overlays provide additional strength to delay the onset of plastic collapse in the primary HAZ, and secondly the overlays change the direction of the HAZ into a plane parallel to the applied load. Through wall yielding is delayed because the HAZ formed by the overlay welds are oriented along a direction that does not promote plastic deformation. This mechanism is illustrated with a numerical simulation, which is discussed further in FIGS. 5D and 5E.

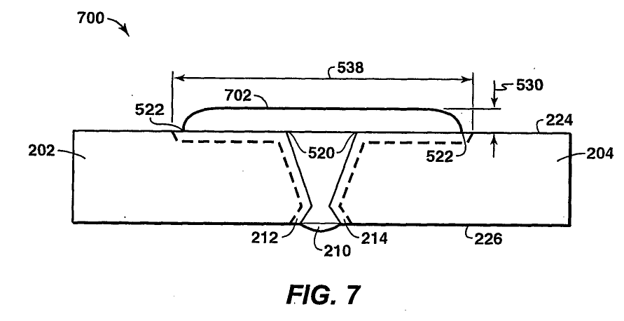

FIGS. 5D and 5E are contour plots generated from numerical simulations to predict the stress-strain response of welded pipe segments. The weld in FIG. 5D represents the configuration of a conventional weld discussed in FIG. 2A, and the numerical model in FIG. 5E represents the overlay weld configuration discussed in FIGS. 5A and 7. Both numerical models explicitly include the primary weld 210, softened HAZ 212 and a weld flaw 562. The simulations assume that pipe material behavior is similar to an X120 grade pipe and a weld material that has a weld overmatch of −10%. The material strength in the HAZ is 10% lower than the base material strength to simulate the response of a softened HAZ. Each color in the contour plot indicates a level of plastic strain. The ranking of strain levels from lowest to highest follows a gray-scale from white to dark gray: white contour level 580, light gray contour level 581, light-medium gray contour level 582, medium contour level 583, and dark gray contour level 584. The dark gray contour level 584 indicates strain values above about 1.5%. Therefore, the areas colored dark gray indicate the location of material points that have deformed significantly past the yield point. FIG. 5D illustrates the dark gray contour level 584 of plastic deformation above 1.5% has propagated through the pipe wall from the tip of the flaw 562 to the weld toe 520 along the softened HAZ 212. The contour plot shows that plastic deformation propagates at an angle 544 that is approximately 45 degrees to a plane 548 perpendicular to the direction 560 of applied load. The simulation indicates that the welded pipe fails due to plastic collapse in the weld region. In FIG. 5E, the deformation initiated at the flaw tip 562, but was arrested at a point 564 where the orientation of the HAZ 212 was changed by the application of overlay weld 568. Also, note that the weld toe 522 produced by the overlay weld 568 is removed far enough from the primary weld to avoid any overlay of the dark gray contour levels 584 or plastic zones that form at the weld toe 522 and in the HAZ 212 at location 564. Therefore, plastic collapse is delayed by ensuring that the overlay width 538 is wide enough such that the angle 570 formed by a line 572 connecting the weld toe 574 formed by the weld root 576 to the weld toe 522 formed by the overlay weld 568 is less than 45 degrees. In this case, through thickness plastic deformation occurs at a location 566 remote from the weld. As such, the simulation shows that the overlay weld successfully moved the location of the failure away from the primary weld 210 to the pipe material.

Accordingly, based on the width 538 and the minimum height 530, the number of overlays or strain welds 504-514 may be adjusted as the overlay width 534 and overlay spacing distance 536 changes with the preferred welding process and consumable used during the welding process. It should be noted that additional overlays of strain welds may be utilized to ensure that a minimum height requirement is satisfied by providing additional layers over the cap weld and toughness welds. Preferably, the number of overlays may be adjusted to satisfy predetermined height and a total overlay width 538 to obtain a desired strain capacity. The geometry requirements may be determined through experimentation with various geometrics and strain capacities.

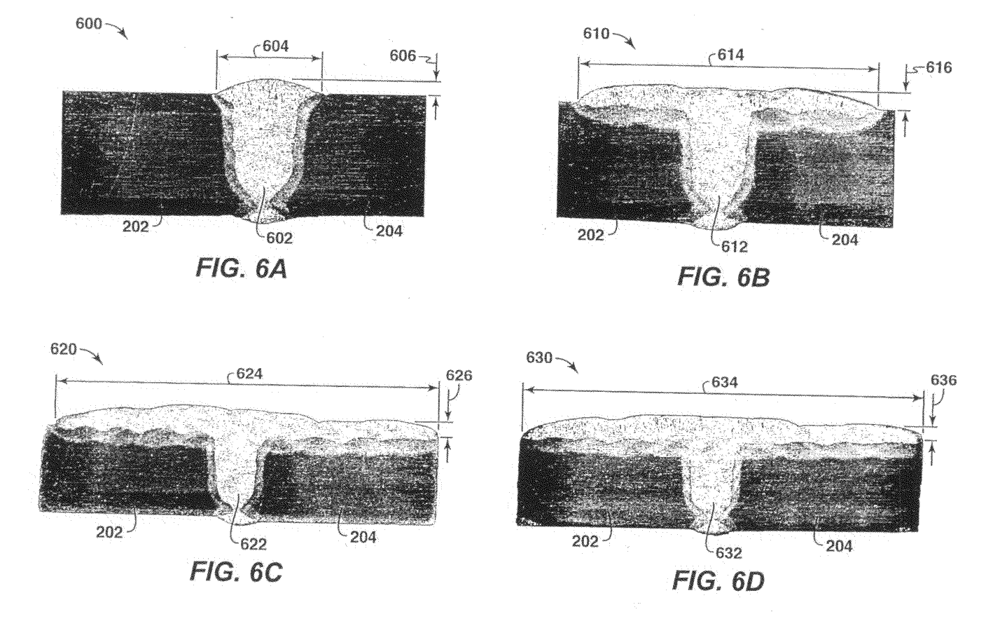

As example of how the geometry influences the strain capacity of pipe segments, FIG. 6A-6D are exemplary profiles of pipe segments from the weld joint of FIGS. 5A-5C in accordance with the present techniques. In FIGS. 6A-6D, pipe segments 202 and 204 were welded together using a pulsed gas metal arc welding process (PGMAW) to form weld joints with different overlay configurations. A welding wire was utilized in this PGMAW process to form the strength weld and the strain welds, which are discussed in FIGS. 5A-5C. The weld overmatch is negative in each of these profiles because the weld metal strength was lower than the strength of the pipe segments 202 and 204. Wide plate specimens, which are utilized in wide plate testing for the oil and gas industry to measure the strain capacity of welded pipelines, may be machined from the welded pipe segments. See, for example, Denys R. M., “Wide Plate Test and its Application to Acceptable Defect” in Proceedings, Welding Institute Conference on Fracture Toughness Testing and Materials, Interpretation and Application, London, June 1982. The wide plate specimens are considered large enough to characterize the structural response of pipelines loaded under conditions of pure tension.

The geometric profiles 600, 610, 620 and 630, which are discussed below, are cross sections taken from material next to one edge of a wide plate of the pipe segments 202 and 204. The profiles 600, 610, 620 and 630 of the weld joints change across the width of the wide plates. The reinforcement geometry of the weld joints in these profiles is summarized in Table 1, as shown below:

TABLE 1

| | | | Weld Flaw | Weld | |
|---|---|---|---|---|---|
| | Minimum | Strain | Geometry | Over- | Normalized |
| Profile | Strain Height | Width | depth × length | match | Capacity |
| 600 | — | — | 3 mm × 50 mm | −4% | 1.0 |
| 610 | 2 mm | 42 mm | 3 mm × 50 mm | −7% | 1.3 |
| 620 | 2.5 mm | 74 mm | 3 mm × 50 mm | −8% | 1.5 |
| 630 | 3 mm | 70 mm | 3 mm × 50 mm | −8% | 2.3 |

It should be noted that the normalized strain capacity in Table 1 may be represented by the following equation:

$$Normalized Strain Capacity = \frac{Measured Strain Capacity}{\begin{matrix}Measured Strain Capacity of \\ Conventional Girth Weld\end{matrix} }$$

In this equation, the measured strain capacity is the strain capacity obtained from a wide plate test conducted on each of the girth weld profiles 600, 610, 620 and 630, while the measured strain capacity of a conventional weld joint is the strain capacity obtained from a conventional girth weld represented by profile 600.

In the FIGS. 6A-6D, the profile 600 is an example of a conventional girth weld or weld joint that does not include any additional weld overlays, such as strain welds or toughness welds, while the profiles 610, 620 and 630 are examples of weld joints that have additional welds to adjust the height and width of the weld joint to enhance the strain capacity. The additional welds, which may include cap welds, toughness welds, and/or strain welds, may be referred to as overlay welds. To begin, FIG. 6A illustrates a geometric profile 600 with a strength weld 602 and a single cap welds that has a width 604, which is approximately 13 millimeters (mm), and a height 606, which is approximately 2 mm. FIG. 6B illustrates a geometric profile 610 with a strength weld 612 and overlay welds that have a minimum height 616, which is 2 mm, and a minimum width 614, which is 42 mm. FIG. 6C illustrates a geometric profile 620 with a strength weld 622 and having overlay welds that have a minimum height 626, which is 2.5 mm, and a minimum width 624, which is 74 mm. Finally, FIG. 6D illustrates the geometric profile 630 with a strength weld 632 and having overlay welds that have a minimum height 636, which is 3 mm, and a minimum width 634, which is 70 mm. The profiles 604, 614, 624 and 630 represent the geometry of each weld at one location along the circumference of the welded pipe segments. The minimum width and height measurements may not necessarily occur at the same location as the location of the cross-sectional profiles shown in FIGS. 6A-6D.

From these different geometry profiles 600, 610, 620 and 630, the minimum strain height and strain width are directly associated with the measured increase in strain capacity, as shown in Table 1. For instance, the normalized strain capacity increased from 1.0 to 2.3 as the profile was changed from profile 600 to profile 630.

As a result, weld joints formed with the overlay or strain welds prevent or delay the onset of plastic collapse in under-matched or even-matched girth welds in the presence of a softened HAZ thereby increasing the strain capacity of a pipeline, such as pipeline 112 that contains flaws in the weld joints or HAZ.

FIG. 7 is an exemplary embodiment of another exemplary weld joint formed from the method of FIG. 4 in accordance with aspects of the present techniques. In this embodiment strain welds 702 are formed by a second fusion welding process selected from gas tungsten arc welding, gas metal arc welding, shielded metal arc welding, and submerged arc welding.

It should be noted that the present techniques may be beneficial in a variety of applications that include welded joints configured to sustain large strains in the direction of the axis of the pipe or abutting members. For instance, the preferred application of the present techniques may include pipelines, as discussed above, which include high strength steels for which available welding consumables create girth welds that do not overmatch the linepipe strength or only overmatch the linepipe strength an amount insufficient to achieve the required strain capacity. However, the present techniques enhance the strain capacity of pipelines where the weld material is stronger than the pipe segment material. That is, the present techniques are not limited to higher strength steels, but provide a secondary method to improve strain capacity for X80 and lower grade materials. In particular, lower grade materials with girth weld overmatching may utilize the present techniques to enhance strain capacity if a softened HAZ is present. Additional weld overlays could be used to enhance the performance of overmatched girth welds.

In addition, it should also be noted that the strain welds may be utilized with toughness welds. For instance, the first two overlay welds 504 and 510 of FIG. 5A may be toughness welds formed on the outer surface 224 adjacent to the weld cap 216 and covering the weld cap toes 520 on the outer surface 224. In this embodiment, the additional strain welds 506, 508, 512 and 514 cover a portion or all of the adjacent welds 504, 506, 510 and/or 512, respectively, and a portion of the surface 224. Accordingly, the strain welds 506, 508, 512 and 514 may alter the geometry to have a specific width and height that enhances the strain capacity of the weld joint 500.

Furthermore, the present techniques also provides a method to increase the strain capacity of an existing pipelines or pipe segments where the strain demand may have increased over the life of the pipeline or may not have been appropriately accounted for during its original design and construction and the existing girth weld properties are not adequate to meet the required strain demand. That is, the present techniques may be utilized to rework existing pipelines to enhance the strain capacity and resistance to brittle failure. Because the welding techniques describes are readily applied in field conditions, it is possible to excavate existing pipelines and add additional weld overlays next to the primary welds as shown in FIG. 5A.

Moreover, it should be noted that in some embodiments of the present techniques, the strength weld and overlay welds, such as the toughness and strain weld materials, may be the same material. In other embodiments, the strength weld and overlay welds may be different for different applications to improve resistance to brittle fracture in the primary weld and optimize strength in the overlay welds. Additionally, the welding processes utilized for the strength weld, weld cap, toughness welds and/or strain welds may also be the same or different welding processes. Also, it should also be noted that the welding process may weld material along the same longitudinal axis or different axes of the pipe segments. For instance, the strength weld may be welded perpendicular to the abutting pipe segments, while the cap weld, toughness weld and strain welds may be welded along the same axis of the abutting pipe segments. Further, it is noteworthy that the welds may be disposed around an inside circumference of the abutting pipe segments.

In addition, the foregoing embodiments have been described in terms of a preferred embodiment. However, it should be understood that other modifications or combinations of portions or aspects of the above described embodiment may be derived without departing from the scope of the invention. These variations include but are not limited to the use of beveling and joining-edge preparation techniques, bevel shape, welding processes and number of weld overlays required to meet the minimum reinforcement geometry.

Further, in another alternative embodiment, blocks 404-408 may be performed with a processing device, such as a computer, server, database or other processor-based device. The processing device may include an application that interacts with a user or automatically generates various weld geometries for the user. The application may be implemented as a spreadsheet, program, routine, software package, or additional computer readable software instructions in an existing program, which may be written in a computer programming language, such as Visual Basic, Fortran, C++, Java and the like. Of course, the processing device may include memory, such as hard disk drives, floppy disks, CD-ROMs and other optical media, magnetic tape, and the like, for storing the application. The processing device may include a monitor, keyboard, mouse and other user interfaces for interacting with a user.

As an example of the operation of the processing device, the user may utilize an application to specify the strain capacity for a weld joint or section of a pipeline, as shown in block 404. The application may be configured to obtain a predetermined strain capacity for a pipeline by providing a user with the ability to enter a strain capacity into the processing device. Then, the application may obtain a pipe segment material and weld metal material for a weld joint. The materials information may again be provided from a user, provided from the application for selection by the user from a list of available materials (i.e. through a graphical user interface or in an Excel spreadsheet), or selected by the application based on the strain capacity. With the pipe segment material and weld metal material, the application may utilize strain capacity data to determine the geometry of a weld joint. The strain capacity data may include previous determined strain capacities that are based on experimental data, modeling data, and/or measured data. This strain capacity data may be associated with different geometries, pipe segment material and/or weld metal material. Once determined, the geometry of the weld joint may be provided to a user via a display or a report.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

What is claimed is:

1. A method to enhance the strain capacity of a weld joint comprising:
forming a strength weld between at least two members using a first welding process and a first weld metal; and
forming at least one strain weld by depositing a second weld metal adjacent to the strength weld using a second welding process, wherein the at least one strain weld is configured to form a weld joint having a specific minimum height and width to handle tensile strain to a specific strain capacity.

2. The method of claim 1 comprising forming at least one toughness weld by depositing a third weld metal directly on the a portion of the strength weld using a third welding process, wherein the at least one toughness weld covers a weld toe of the strength weld and the at least one strain weld covers a weld toe of the at least one toughness weld.

3. The method of claim 1 wherein the at least two members comprise pipe segments.

4. The method of claim 1 wherein the first welding process and second welding process comprise at least one of gas tungsten arc welding, gas metal arc welding, shielded metal arc welding, submerged arc welding, fluxed core arc welding, plasma arc welding, and any combination thereof.

5. The method of claim 4 wherein the first welding process and the second welding process are different.

6. The method of claim 4 wherein the first welding process and the second welding process are the same.

7. The method of claim 1 wherein the width between the weld toe of the strength weld and the weld toe of the strain weld covers at least the width of a heat-affected zone on the surface of each of the at least two member created by formation of the strength weld, and forms an angle of greater than about 0 degrees and less than or equal to about 45 degrees with a plane parallel to the direction of maximum tensile load across the weld joint.

8. The method of claim 1 wherein the first weld metal and the second weld metal comprise at least one of ferritic welding consumables, austenitic welding consumables and any combination thereof.

9. The method of claim 8 wherein the first weld metal and the second weld metal are the same.

10. The method of claim 1 wherein the at least two members are utilized to transport hydrocarbons.

11. The method of claim 1 further comprising determining the specific minimum height and width of the at least one strain weld to achieve a strain capacity to a specific strain demand.

12. The method of claim 11 wherein determining comprises using at least one of experience, experimentation, calculations and any combination thereof.

13. The method of claim 11 wherein determining comprises using a numerical simulation model.

14. A system comprising:
a first tubular member;
a second tubular member abutted to the first tubular member; and
a weld joint having a strength weld and a plurality of strain welds and coupling the first tubular member and the second tubular member, wherein the weld joint has a specific minimum height and width to handle tensile strain up to a specific strain capacity.

15. The system of claim 14 wherein the first tubular member is in fluid communication with a reservoir.

16. The system of claim 14 comprising a tree coupled to the first tubular member and a subsurface facility coupled to the second tubular member.

17. The system of claim 14 wherein the weld joint comprises at least one toughness weld disposed partially between the strength weld and one of the plurality of strain welds, wherein the at least one toughness weld covers a weld toe of the strength weld and the at least one strain weld covers a weld toe of the one of the plurality of strain welds.

18. The system of claim 14 wherein the at least two members comprise pipe segments.

19. The system of claim 14 wherein a width between a weld toe of the strength weld and a weld toe of the plurality of strain welds covers at least the width of a heat-affected zone on the surface of each of the first tubular member and the second tubular member created by formation of the strength weld, and forms an angle of greater than about 0 degrees and less than or equal to about 45 degrees with a plane parallel to the direction of maximum tensile load across the weld joint.

20. The system of claim 14 wherein the first tubular member and the second tubular member are utilized to transport hydrocarbons.

21. An apparatus comprising:
a processor;
a memory coupled to the processor; and
an application accessible by the processor, wherein the application is configured to:
obtain a predetermined strain capacity for a well completion;
obtain a pipe segment material and weld metal material for a weld joint;
utilize strain capacity data to determine the geometry of a weld joint based on the pipe segment material and weld metal material; and
provide the geometry of a weld joint to a user.

22. The apparatus of claim 21 wherein the strain capacity data comprises previous measured strain capacity data for different geometries of weld joints.

23. The apparatus of claim 21 wherein the application provides the geometry of the weld joint by displaying the geometry of the weld joint on a monitor.

24. The apparatus of claim 21 wherein the geometry of the weld joint is utilized to couple pipe segments that transport hydrocarbons from a well.

25. A method to enhance the strain capacity of a weld joint comprising:
determining a specific minimum height and width of at least one strain weld to achieve a strain capacity to a specific strain demand
forming a strength weld between at least two members using a first welding process and a first weld metal; and
forming the at least one strain weld by depositing a second weld metal adjacent to the strength weld using a second welding process, wherein the at least one strain weld is configured to form a weld joint having the specific minimum height and width.

26. The method of claim 25 wherein determining comprises using at least one of experience, experimentation, calculations and any combination thereof.

27. The method of claim 25 wherein determining includes utilizing a numerical simulation model.

28. A method to determine a weld geometry comprising:
determining a specific strain demand;
determining a pipe segment material;
determining a weld material and a welding process; and
determining a specific minimum height and width of at least one strain weld to achieve a strain capacity to the specific strain demand.

29. The method of claim 28 comprising using at least one of experimental data, experiential data, measured data and any combination thereof.

30. The method of claim 28 comprising at least one of sampling soil conditions, characterizing potential seismic activity, identifying fault lines, predicting frost heave, predicting thaw settlement, and any combination thereof.

31. The method of claim 28 wherein the pipe segment material may be selected from the group consisting of steel or steel alloys.

32. The method of claim 28 wherein the weld material and weld process are determined based on the determined pipe material.

33. The method of claim 28 wherein the weld material and weld process are selected based on access to public or proprietary databases of weld performance.

34. The method of claim 28 comprising measuring the specific strain capacity, wherein the measuring includes tensile strain tests of welded pipe segments.

35. The method of claim 28 comprising utilizing a numerical simulation model.
